(19) United States
(12) Patent Application Publication
(10) Pub. No.: US 2014/0210301 A1
(43) Pub. Date: Jul. 31, 2014

(54) Stator of an Alternator

(71) Applicant: Victory Industrial Corporation, New Taipei City (TW)

(72) Inventors: Chun-Yuan WANG, New Taipei City (TW); Chih-Chin CHANG, New Taipei City (TW)

(73) Assignee: Victory Industrial Corporation, New Taipei City (TW)

(21) Appl. No.: 14/167,850

(22) Filed: Jan. 29, 2014

Related U.S. Application Data
(63) Continuation-in-part of application No. 13/753,554, filed on Jan. 30, 2013.

(30) Foreign Application Priority Data
Jan. 29, 2014 (TW) 103 103 637

(51) Int. Cl. H02K 1/16; H02K 3/30; H02K 3/34; H02K 3/12; H02K 1/02

(52) U.S. Cl. CPC H02K 1/16; H02K 3/12; H02K 1/02; H02K 3/345; H02K 3/30
USPC 310/208; 310/184; 310/216.001; 310/215

(57) ABSTRACT

The present invention relates to a stator of an alternator, providing an elongated stator body having a plurality of parallel grooves, winding a plurality of wires in the plurality of different grooves, and then rolling the elongated stator body wound with the wires into an annular shape to form an annular stator.

### CROSS-REFERENCE TO RELATED APPLICATIONS

This application claims the benefit of priority to each of the following commonly-owned applications, each of which is herein incorporated by reference in their entirety for all purposes:
U.S. patent application Ser. No. 13/753,554, filed Jan. 30, 2013, entitled “Annular-Shaped Stator Structure and Method of Manufacture,” and
TW patent application no. 103 103 637, filed Jan. 29, 2014, entitled “Stator of an Alternator.”

### BACKGROUND OF THE INVENTION

The present invention relates to a stator of an alternator, and in particular, to a stator of an alternator of automobiles.

The alternator is one kind of generator and can convert mechanical energy to electrical energy in a form of alternating current (AC). A vehicle alternator converts mechanical energy produced by an engine to electrical energy for charging a battery so as to supply electrical power to other electrical appliances in the vehicle and to activate a motor to drive the engine.

The alternator generally has an annular stator and a rotor received in the annular stator, wherein the stator is wound with wires. By means of the rapid movement of the rotor within the stator, relative movement occurs between the wires and the magnetic field produced by the wires and the rotor so that an induced electromotive force (voltage) is generated in the wires. An output voltage of the alternator is directly proportional to the number of coils of the wires. Therefore, the greater the density of the wires on the stator is, the greater the electrical energy generated by the generator is.

The traditional annular stator has grooves made by means of mechanical machining, and wires are wound between the grooves to facilitate the generation of electricity through induction. However, since the stator is annular, openings of the grooves are oriented toward the center thereof, and this structure would make the winding action difficult. In addition, since the spacing between the side walls of the grooves is tapered as the groove walls extend towards the center of the stator, it is difficult to neatly and compactly arrange the wires in each groove. As a result, the number of coils of the wires wound on the stator is often insufficient, resulting in that the density of the wires cannot be increased and the energy generation capacity is insufficient. In order to obtain the desired capacity in generating electricity, it is necessary to increase the number of coils of the wires, which not only increases the thickness of the winding of the wires, making the volume of the alternator huge, but also leads to a rise in the operation temperature of the alternator, and loss due to -resistance of stator coils is high. Hence, the conventional stator structure not only limits the overall performance of the alternator but also limits the overall performance of other components that must use the stator structure.

### SUMMARY OF THE INVENTION

In view of the shortcomings of the prior art, the inventor proposes a stator of an alternator, which can make the wire winding action more convenient and can effectively increase the density of the wires in the grooves of the stator, thereby decreasing the thickness of winding of the wires and increasing the capacity in generating electricity of the alternator.

In order to achieve the above objective, the present invention provides a stator of an alternator comprising an elongated stator body, provided with a plurality of parallel grooves on a first side, and respectively defining a first end and a second end on two ends; and a plurality of wires, respectively wound in the plurality of different grooves, wherein each coil of the wires comprises at least one wire; wherein after the wires are wound onto the elongated stator body, the elongated stator body is deformed into an annular shape so that the first side of the elongated stator body faces inwardly and the first end and the second end of the elongated stator body are combined with each other.

According to a preferred embodiment of the invention, the elongated stator body comprises a material, and the material is selected from the group consisting of a cold rolled steel plate (SPCC) and silicon steel.

According to a preferred embodiment of the invention, surfaces of each of the grooves are covered with an electrically insulating material. The electrically insulating material comprises a material selected from the group consisting of a pressed cardboard, a plastic film, a polyester film, an aramid paper and an epoxy resin.

According to a preferred embodiment of the invention, each of the wires has a first end and a second end, and the first end and the second end of each of the wires are combined to form an outlet portion upon completion of winding.

According to a preferred embodiment of the invention, the first end and the second end of each of the wires are combined with each other by means of welding.

According to a preferred embodiment of the invention, the outlet portions of the wires are disposed adjacently.

According to a preferred embodiment of the invention, upon completion of winding, the wires are compacted to increase the tightness between the wires in the grooves.

According to a preferred embodiment of the invention, each of the wires is compacted through a hydraulic mechanism.

According to a preferred embodiment of the invention, the wires are enameled copper wires.

According to a preferred embodiment of the invention, the elongated stator body forms an annular stator by means of rolling.

According to a preferred embodiment of the invention, the elongated stator body forms an annular stator by means of cold rolling.

According to a preferred embodiment of the invention, the first end and the second end of the elongated stator body are combined with each other by means of welding.

According to a preferred embodiment of the invention, the elongated stator body is provided with at least one notch on a second side opposite the first side, so that when the stator is mounted to a case of the alternator, the notch is disposed for passing of a fastener, making the combination of the stator and the case of the alternator closer.

The present invention further provides a stator of an alternator comprising an annular stator body, provided with a plurality of grooves on an inner side; and a plurality of wires, respectively wound in the plurality of different grooves, wherein each coil of the wires comprises at least one wire, wherein each of the wires has a first end and a second end, and the first end and the second end of each of the wires are combined to form an outlet portion upon completion of winding, and wherein the outlet portions of the wires are disposed adjacently.

According to a preferred embodiment of the invention, the annular stator body has a first end and a second end, and the first end and the second end of the annular stator body are combined with each other by means of welding.

According to a preferred embodiment of the invention, the first end and the second end of each of the wires are combined with each other by means of welding.

According to a preferred embodiment of the invention, the elongated stator body comprises a material, and the material is selected from the group consisting of a cold rolled steel plate (SPCC) and silicon steel.

According to a preferred embodiment of the invention, surfaces of each of the grooves are covered with an electrically insulating material. The electrically insulating material comprises a material selected from the group consisting of a pressed cardboard, a plastic film, a polyester film, an aramid paper and an epoxy resin.

According to a preferred embodiment of the invention, upon completion of winding, the wires are compacted to increase the tightness between the wires in the grooves.

According to a preferred embodiment of the invention, each of the wires is compacted through a hydraulic mechanism.

According to a preferred embodiment of the invention, the wires are enameled copper wires.

According to a preferred embodiment of the invention, the elongated stator body is provided with at least one notch on a second side opposite the first side, so that when the stator is mounted to a case of the alternator, the notch is disposed for passing of a fastener, making the combination of the stator and the case of the alternator closer.

In order to better understand the following detailed description of the present invention, the foregoing has rather broadly generalized the features and technical advantages of the present invention. The additional features and advantages of the present invention will be described below. Persons skilled in the art should conceive that the concepts and specific embodiments disclosed can be easily modified or designed as the basis of other structures implementing the same purposes of the present invention. Persons skilled in the art also should conceive that such equivalent constructions do not depart from the spirit and scope of the present invention claimed in the claims.

### BRIEF DESCRIPTION OF THE DRAWINGS

To understand the present invention and advantages of the present invention more thoroughly, please refer to the following description in combination with the accompanying drawings, wherein:

FIG. 1 is a schematic three-dimensional exploded view of an elongated stator of an alternator according to the present invention;

FIG. 2 is a schematic view of compacting wires in grooves of an elongated stator body by using a hydraulic mechanism according to the present invention;

FIG. 3 is a schematic view of deforming the elongated stator body by using a rolling device according to the present invention;

FIG. 4 is a schematic view of welding the elongated stator body with a welding torch after winding it into an annular shape according to the present invention;

FIG. 5A is a schematic view of another embodiment of the elongated stator according to the present invention;

FIG. 5B is a schematic view of another embodiment of the annular stator according to the present invention;

FIG. 6 is a schematic three-dimensional exploded view of a stator of an alternator according to the present invention;

FIG. 7 is a schematic three-dimensional view of a stator of an alternator according to the present invention; and

FIG. 8 is a flow chart of a method for manufacturing a stator of an alternator according to the present invention.

### DETAILED DESCRIPTION

The following embodiments further describe the present invention. They are only intended to describe the present invention and illustrate various advantages of particular embodiments of the present invention, which does not mean that the present invention is only limited to such a presentation manner.

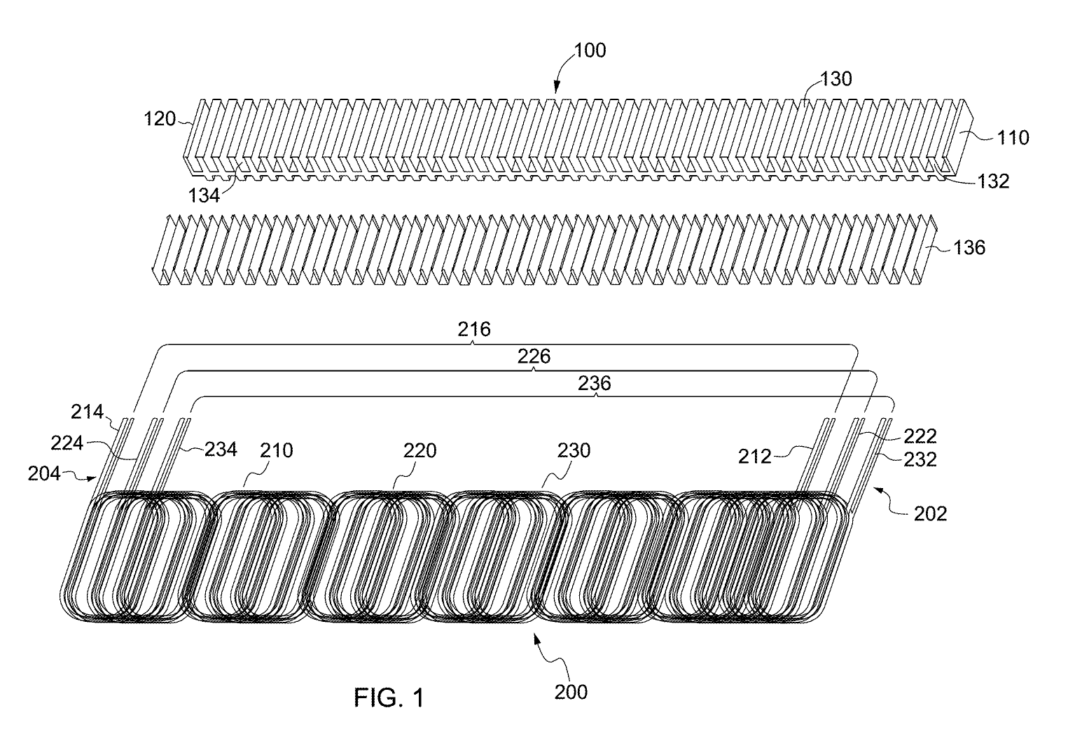

FIG. 1 is a schematic three-dimensional exploded view of an elongated stator of an alternator according to the present invention. As shown in FIG. 1, the elongated stator of an alternator according to the present invention mainly has an elongated stator body 100, the elongated stator body 100 has a first end 110 and a second end 120, and is convexly provided with a plurality of parallel teeth 132 on a first side 130, and a groove 134 is formed between the adjacent teeth 132 so that the grooves 134 also show a parallel architecture. In a preferred embodiment of the present invention, the elongated stator body 100 is formed by materials which can maintain electrical and magnetic properties after the shape changes, for example, cold rolled steel plate (SPCC), silicon steel or other similar materials.

The grooves 134 of the elongated stator body 100 can be internally laid with an electrically insulating material 136. In a preferred embodiment of the present invention, the grooves 134 are each provided with a separate electrically insulating material 136 (as shown in FIG. 1). An alternative embodiment of the present invention may use a continuous sheet/plate-like electrically insulating material 136, and a part of the electrically insulating material is disposed along surfaces of two or more grooves 134 and the teeth 132. In the preferred embodiment of the present invention, the electrically insulating material 136 is made of, for example, a pressed cardboard, a plastic film, a polyester film, an aramid paper, an epoxy resin or other similar non-conductive materials.

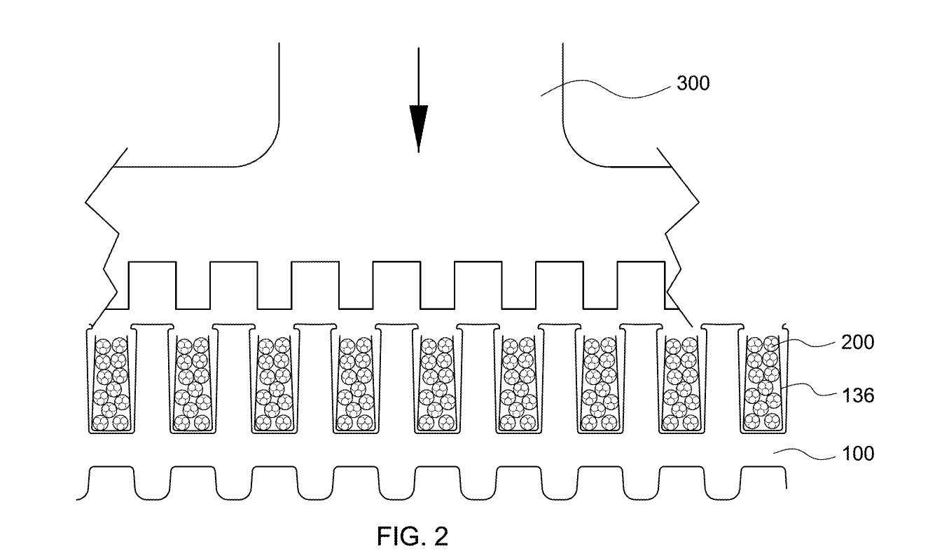

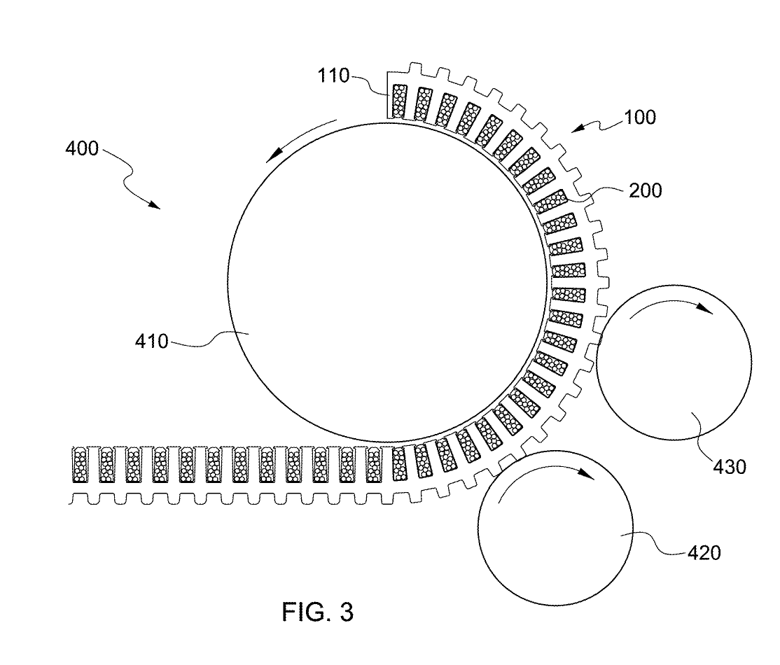

The grooves 134 of the elongated stator body 100 are available for winding the wires 200. The wire 200 according to the present invention consists of a plurality of wire groups 210, 220 and 230, and each wire group 210, 220 and 230 has at least one wire 200, and each wire 200 has a first end 202 and a second end 204. For example, when each the wire group 210, 220 and 230 only has one wire 200, each turn has a wire 200 (as shown in FIG. 3); that is to say, each wire group 210, 220 and 230 is wound with one wire 200 at a time. When each wire group 210, 220 and 230 has three wires 200, each turn has three wires 200 (as shown in FIG. 2); that is to say, each wire group 210, 220 and 230 is wound with three wires 200 at a time. When each wire group 210, 220 and 230 is wound with multiple wires 200, wires 200 with smaller diameters can be used for winding so that gaps between the wires 200 in the grooves 134 can be decreased and tightness between the wires 200 can be increased, thereby increasing the density of the wires in the grooves 134. Higher wire density can make the stator produce a higher induced current when operating.

In the embodiment shown in FIG. 1, the wire is divided into three wire groups 210, 220 and 230, and the wires 200 in each group respectively have a first end 212, 222 or 232 and a second end 214, 224 or 234. So, when the wires 200 are wound, the wires 200 of the first wire group 210 can be wound back and forth in the first, fourth, seventh and tenth grooves 134 of the elongated stator body 100, and the wires 200 in the second wire group 220 can be wound back and forth in the second, fifth, eighth and eleventh grooves 134 of the elongated stator body 100, while the wires 200 in the third wire group 230 can be wound back and forth in the third, sixth, ninth and twelfth grooves 134 of the elongated stator body 100. In a preferred embodiment of the present invention, the wires 200 are enameled copper wires, but other conductive materials can also be selected in alternative embodiments.

The wires 200 according to the present invention, upon completion of winding, can use a hydraulic mechanism 300 to perform an action of compacting the wires 200 in the grooves 134 so as to decrease gaps between the wires 200 in the grooves 134 and increase tightness between the wires 200, thereby increasing the density of the wires in the grooves 134. The present invention can also use any other device to perform the compacting action, and the hydraulic mechanism 300 is only a preferred embodiment.

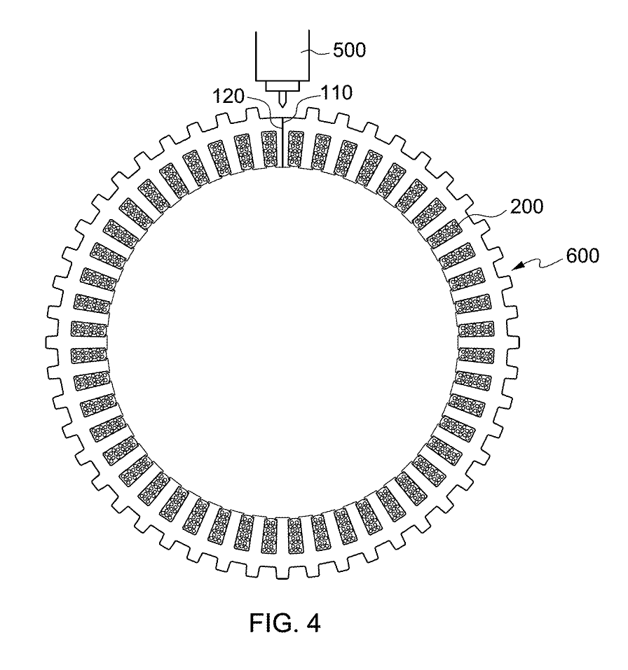

After the elongated stator body 100 completes the actions of winding and compacting the wires 200, it can be deformed into an annular stator. A preferred embodiment of the present invention uses a rolling device 400 to roll the elongated stator body 100. As shown in FIG. 3, the elongated stator body 100 is conveyed to the rolling device 400 provided with three rollers 410, 420 and 430 for rolling via a conveyor belt (not shown). In the rolling process, upon bending deformation of the elongated stator body 100, the first side 130 of the elongated stator body 100 is inward, and the first end 110 thereof is gradually close to the second end 120. When the first end 110 and the second end 120 of the elongated stator body 100 are in contact, the elongated stator body is deformed into an annular shape. At this time, the first end 110 and the second end 120 of the elongated stator body 100 can be welded through a welding torch 500, thereby forming an annular stator 600 (as shown in FIG. 4). The present invention, in the embodiments, first lays the electrically insulating material 136 on the elongated stator body 100 and winds the wires 200, and then deforms the elongated stator body into the annular stator 600. However, the present invention, in an alternative embodiment, can also first deform the elongated stator body 100 into the annular stator 600 and then lay the electrically insulating material 136 and wind the wires 200, and can also first lay the electrically insulating material 136 on the elongated stator body 100 then deform the elongated stator body 100 into the annular stator 600 and finally wind the wires 200. In addition, the present invention, in the embodiments, winds the elongated stator body 100 into an annular shape by means of cold rolling of a rolling process. However, the present invention can also deform the elongated stator body 100 into the annular stator 600 in other manners.

Besides, upon completion of winding the wire 200, the first end 202 and the second end 204 thereof are respectively gathered at the first end 110 and the second end 120 of the elongated stator body 100, and the first end 202 and the second end 204 of each wire 200 are combined (e.g., by means of welding) to form an outlet portion 216, 226 or 236 (please refer to FIG. 1), and the outlet portions 216, 226 and 236 of each wire 200 can be disposed adjacently, so that when the stator operates as the outlet portions 216, 226 and 236 are gathered together, the cooling efficiency of the remaining part of the stator is improved, thereby increasing the service life of the stator.

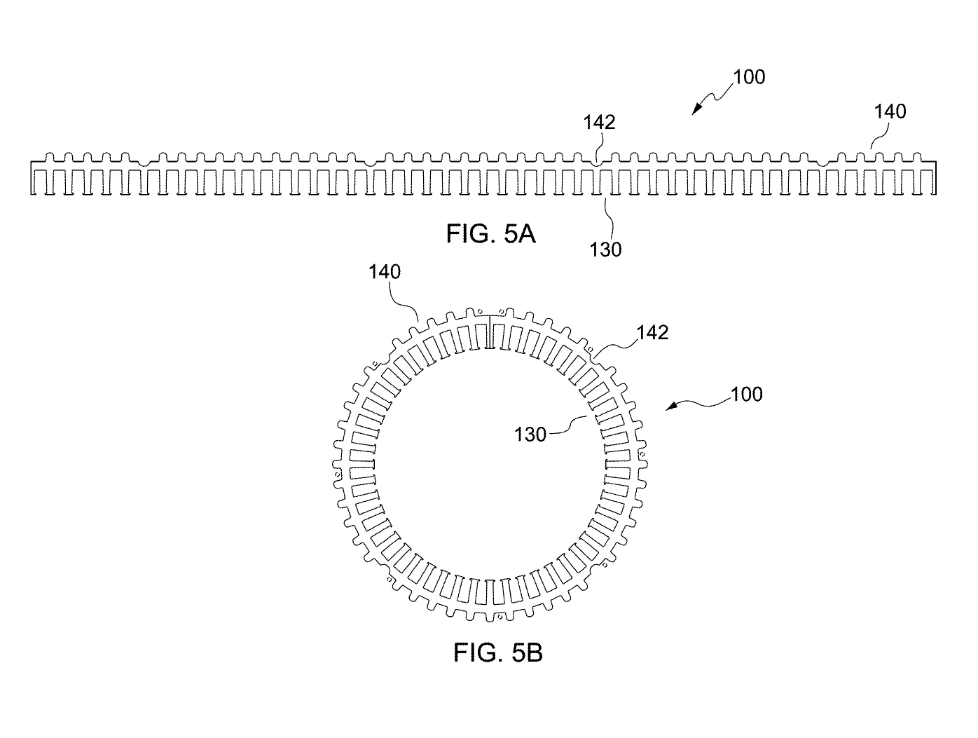

As shown in FIGS. 5A and 5B, the elongated stator body 100 according to the present invention can be provided with at least one notch 142 on a second side 140 opposite the first side 130. Thus, when the elongated stator body 100 is deformed into the annular stator 600 to be mounted to a case (not shown) of the alternator, the notch 142 is available for passing of a lock firmware (e.g., a locking bolt) so as to secure the stator in the case of the alternator. Due to the design of the notch 142, interference of the lock firmware with the stator can be reduced, and gaps between the stator and the case of the alternator can be decreased, thereby making the structure of the alternator tighter.

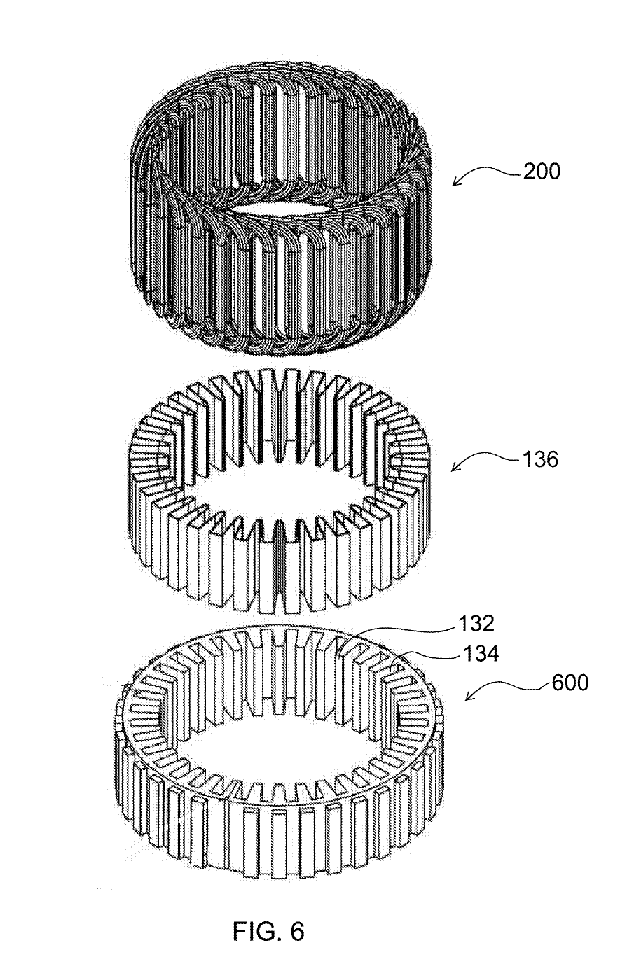

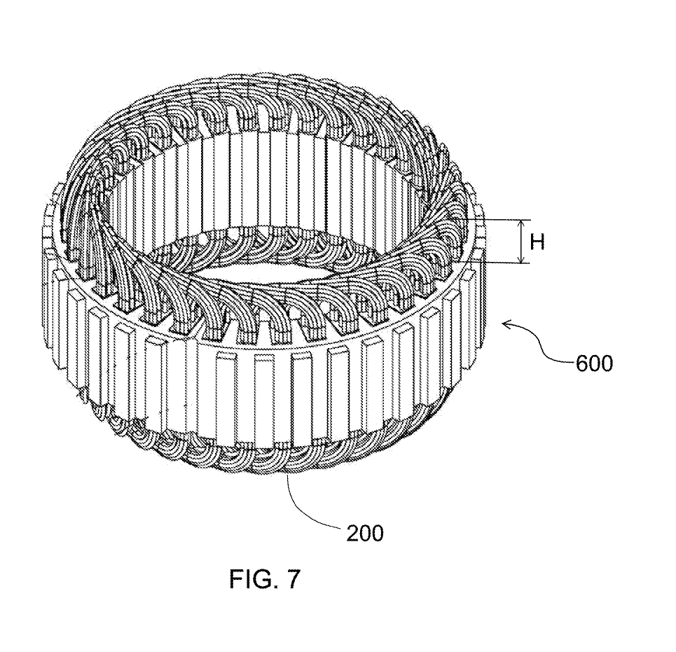

FIGS. 6 and 7 are a schematic three-dimensional exploded view and a schematic three-dimensional view of a stator of an alternator according to the present invention. As shown in FIGS. 6 and 7, in place of the traditional method of directly manufacturing an annular stator structure and winding the annular stator structure, the present invention first provides an elongated stator body 100 and can directly perform the action of winding wires 200 around the elongated stator body 100. Since an elongated structure is obviously more convenient for the winding action than an annular structure, the density of the wires in the grooves 134 of the stator can be significantly improved, which can not only effectively reduce the temperature of the alternator but can also reduce the loss due to the resistance of the stator. In addition, when the elongated stator body 100 is wound, as its winding action is easier and simpler, a height H of the wires protruding above the stator can be effectively reduced, thereby reducing the probability of damage to the wires 200 and increasing the tightness of the overall structure.

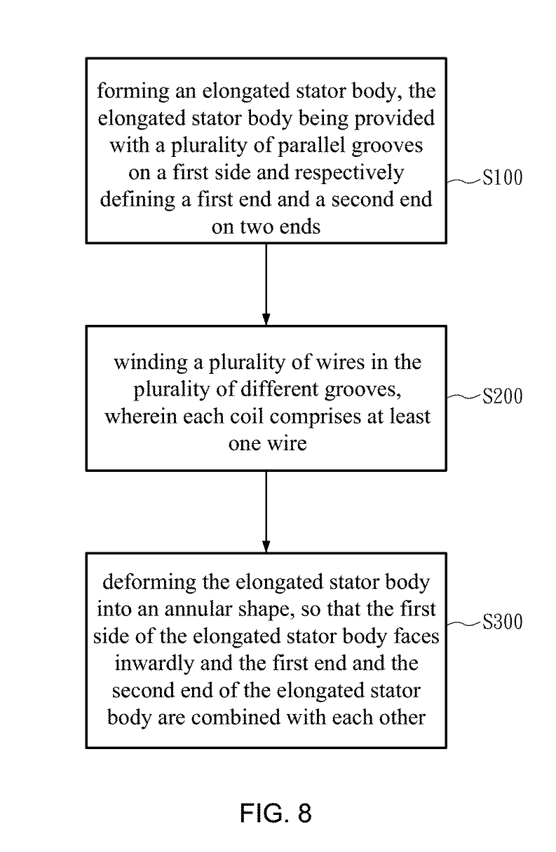

As shown in FIG. 8, the present invention also provides a method for manufacturing a stator of an alternator, including: forming an elongated stator body, the elongated stator body being provided with a plurality of parallel grooves on a first side and respectively defining a first end and a second end on two ends (step S100); winding a plurality of wires in the plurality of different grooves, wherein each coil comprises at least one wire (step S200); and deforming the elongated stator body into an annular shape so that the first side of the elongated stator body faces inwardly and the first end and the second end of the elongated stator body are combined with each other (step S300).

The method for manufacturing a stator of an alternator according to the present invention can lay an electrically insulating material on surfaces of the grooves of the elongated stator body and can dispose at least one notch on a second side of the elongated stator body. In addition, after the wires are wound around the elongated stator body, the wires can be compacted again to increase the density of the wires in the grooves. Moreover, each wire has a first end and a second end, and upon completion of winding of the wires, the first end and the second end of each wire are combined with each other to form an outlet portion, and the outlet portions of the wires can be disposed adjacently.

In a preferred embodiment of the present invention, the elongated stator body is formed by materials which can maintain electrical and magnetic properties after the shape changes, for example, cold rolled steel plate (SPCC), silicon steel or other similar materials. The electrically insulating material is made of, for example, a pressed cardboard, a plastic film, a polyester film, an aramid paper, an epoxy resin or other similar non-conductive materials. The wires may be enameled copper wires.

In a preferred embodiment of the present invention, the elongated stator body is deformed into an annular shape by means of rolling in a rolling process.

In a preferred embodiment of the present invention, the first end and the second end of the elongated stator body are combined with each other by means of welding. The first end and the second end of each wire are also combined with each other by means of welding.

The stator according to the present invention is applied to alternator systems, for example, alternator systems of power systems and vehicles. The stator according to the present invention especially serves as a stator structure of an alternator for automobiles.

Although the present invention and its advantages have been described in detail, it should be understood that various variations, alternatives and modifications can be made herein without departing from the spirit and scope of the present invention as defined by the appended claims. Moreover, the scope of the present invention is not intended to be limited to the specific embodiments of processes, machines, manufactured things, material compositions, means, methods and steps as recited in the specification. Persons skilled in the art can easily recognize from the disclosure of the present invention that the present invention takes advantage of the processes, machines, manufactured things, material compositions, means, methods and steps existing or later to be developed, performing substantially the same function or achieving substantially the same effect as those of the corresponding embodiments recited herein. Accordingly, the appended claims are intended to include such processes, machines, manufactured things, material compositions, means, methods or steps in their scopes.

### DESCRIPTIONS ABOUT REFERENCE SIGNS

100 Elongated stator body

110 First end of the elongated stator body

120 Second end of the elongated stator body

130 First side

132 Tooth

134 Groove

136 Electrically insulating material

140 Second side

142 Notch

200 Wire

202, 212, 222, 232 First end

204, 214, 224, 234 Second end

210, 220, 230 Wire group

216, 226, 236 Outlet portion

300 Hydraulic mechanism

400 Rolling device

410, 420, 430 Roller

500 Welding torch

600 Annular stator

H Height

We Claim:

1. A stator of an alternator, comprising:
an elongated stator body, provided with a plurality of parallel grooves on a first side and respectively defining a first end and a second end on two ends; and
a plurality of wires, respectively wound in the plurality of different grooves, wherein each coil of the wires comprises at least one wire;
wherein after the wires are wound onto the elongated stator body, the elongated stator body is deformed into an annular shape so that the first side of the elongated stator body faces inwardly and the first end and the second end of the elongated stator body are combined with each other.

2. The stator of an alternator according to claim 1, wherein the elongated stator body comprises a material, and the material is selected from the group consisting of a cold rolled steel plate (SPCC) and silicon steel.

3. The stator of an alternator according to claim 1, wherein surfaces of each of the grooves are covered with an electrically insulating material.

4. The stator of an alternator according to claim 3, wherein the electrically insulating material comprises a material selected from the group consisting of a pressed cardboard, a plastic film, a polyester film, an aramid paper and an epoxy resin.

5. The stator of an alternator according to claim 1, wherein each of the wires has a first end and a second end, and the first end and the second end of each of the wires are combined to form an outlet portion upon completion of winding.

6. The stator of an alternator according to claim 5, wherein the first end and the second end of each of the wires are combined with each other by means of welding.

7. The stator of an alternator according to claim 5, wherein the outlet portions of the wires are disposed adjacently.

8. The stator of an alternator according to claim 1, wherein upon completion of winding, the wires are compacted to increase the tightness between the wires in the grooves.

9. The stator of an alternator according to claim 8, wherein each of the wires is compacted through a hydraulic mechanism.

10. The stator of an alternator according to claim 1, wherein the wires are enameled copper wires.

11. The stator of an alternator according to claim 1, wherein the elongated stator body forms an annular stator by means of rolling.

12. The stator of an alternator according to claim 1, wherein the elongated stator body forms an annular stator by means of cold rolling.

13. The stator of an alternator according to claim 1, wherein the first end and the second end of the elongated stator body are combined with each other by means of welding.

14. The stator of an alternator according to claim 1, wherein the elongated stator body is provided with at least one notch on a second side opposite the first side, so that when the stator is mounted to a case of the alternator, the notch is disposed for passing of a fastener, making the combination of the stator and the case of the alternator closer.

15. A stator of an alternator, comprising:
an annular stator body, provided with a plurality of grooves on an inner side; and
a plurality of wires, respectively wound in the plurality of different grooves, wherein each coil of the wires comprises at least one wire, wherein each of the wires has a first end and a second end, and the first end and the second end of each of the wires are combined to form an outlet portion upon completion of winding, and wherein the outlet portions of the wires are disposed adjacently.

16. The stator of an alternator according to claim 15, wherein the annular stator body has a first end and a second end, and the first end and the second end of the annular stator body are combined with each other by means of welding.

17. The stator of an alternator according to claim 15, wherein the first end and the second end of each of the wires are combined with each other by means of welding.

18. The stator of an alternator according to claim 15, wherein the elongated stator body comprises a material, and the material is selected from the group consisting of a cold rolled steel plate (SPCC) and silicon steel.

19. The stator of an alternator according to claim 15, wherein surfaces of each of the grooves are covered with an electrically insulating material.

20. The stator of an alternator according to claim 19, wherein the electrically insulating material comprises a material selected from the group consisting of a pressed cardboard, a plastic film, a polyester film, an aramid paper and an epoxy resin.

21. The stator of an alternator according to claim 15, wherein upon completion of winding, the wires are compacted to increase the tightness between the wires in the grooves.

22. The stator of an alternator according to claim 21, wherein each of the wires is compacted through a hydraulic mechanism.

23. The stator of an alternator according to claim 15, wherein the wires are enameled copper wires.

24. The stator of an alternator according to claim 15, wherein the elongated stator body is provided with at least one notch on an outer side, so that when the stator is mounted to a case of the alternator, the notch is disposed for passing of a fastener, making the combination of the stator and the case of the alternator closer.

25. An alternator, comprising a stator of claim 1.

26. The alternator according to claim 25, wherein the alternator is applied to an automobile.
